(19) United States
(12) Patent Application Publication
(10) Pub. No.: US 2015/0275053 A1
(43) Pub. Date: Oct. 1, 2015

(54) RUBBER MATERIAL AND SEAL COMPONENT AND HOSE

(71) Applicant: TOYODA GOSEI CO., LTD., Kiyosu-shi (JP)

(72) Inventors: Naoki IWASE, Kiyosu-shi (JP); Hidekazu KURIMOTO, Kiyosu-shi (JP); Teruyoshi SUSAKI, Kiyosu-shi (JP)

(21) Appl. No.: 14/660,072

(22) Filed: Mar. 17, 2015

(30) Foreign Application Priority Data
Mar. 28, 2014 (JP) 2014-068484

(51) Int. Cl. C09J 109/00

(52) U.S. Cl. CPC C09J 109/00

(57) ABSTRACT

The present invention provides a rubber material including rubber polymer with which a low molecular weight hydrocarbon-based oil having a weight average molecular weight of 1500 or less and a high molecular weight hydrocarbon-based oil having a weight average molecular weight of 5000 or more are blended.

### TECHNICAL FIELD

The present invention relates to a rubber material, and a seal component and a hose containing the rubber material.

### BACKGROUND ART

As a method for increasing sound insulation property of seal components formed of rubber material and used for vehicles, buildings, and other applications, there are a known method to increase a specific gravity of the rubber material based on the specific gravity rule (a material having a higher specific gravity has more excellent sound insulation property) and a known method to control a mode of foaming the rubber material (such as closed cells and open cells).

As a method for increasing a specific gravity of the rubber material, an expansion ratio is decreased in the case of using a foam rubber material, as disclosed in Patent Document 1.

In addition, there is a method to increase an amount of use of an additive having a high specific gravity. This method, however, may causes problems such as deterioration in physical property and increase in weight, which cause need for change in product shape and need for a support member. It is a problem particularly for seal components for vehicles that the recent requirement of lightweight cannot be met.

As a method for controlling a foaming mode of a rubber material, Patent Document 2 discloses a method in which two types of foaming agents having different grain sizes are used, and foams having a relatively large diameter and foams having a relatively small diameter are produced in the foam rubber material. This prevents the foams from connecting each other to form open cells, so that each foam exists as a single cell, and sound insulation property is improved. However, this method has a difficulty in setting optimal foaming conditions, and the physical property may deteriorate depending on the setting.

### CITATION LIST

### Patent Document

Patent Document 1: Japanese Patent Application Publication No. 2011-11602

Patent Document 2: Japanese Patent Application Publication No. 2013-136661

### SUMMARY OF INVENTION

### Technical Problem

An object of the present invention is to provide a rubber material, a seal component, and a hose that are capable of increasing sound insulation property in accordance with a novel idea, without deterioration in physical property or increase in weight, instead of increasing a specific gravity of the rubber material or controlling the foaming mode.

### Solution to Problem

A blended oil is added to the rubber material for the purpose of increase in volume, plasticization, and softening (increase in processability). For example, mainly in rubber material manufacturers, an extender oil (extender) is added to a rubber material for the purpose of increase in volume and plasticization, and the rubber material is shipped as extension rubber or oil-extended rubber. In addition, mainly in rubber processing manufacturers, process oil (working oil) is added to a rubber material for the purpose of softening (increase in processability), and the rubber material is kneaded and processed.

Blended oils such as extender oils and process oils include paraffin-based oils, naphthene-based oils, aromatic oils, or blended oils thereof. Each of the blended oils used has a low molecular weight with a weight average molecular weight of about 500 to 1000, in consideration of processability. Oil having a low molecular weight has low viscosity, and oil having a high molecular weight has high viscosity.

The inventors of the present invention focused on the blended oils. The inventors have finally found that sound insulation property is increased by addition of oil having a high molecular weight, and have made the present invention as a result of further study.

A rubber material of the present invention includes rubber polymer with which a low molecular weight hydrocarbon-based oil having a weight average molecular weight of 1500 or less and a high molecular weight hydrocarbon-based oil having a weight average molecular weight of 5000 or more are blended.

The high molecular weight hydrocarbon-based oil is preferably blended in an amount of 10 to 90 percent by mass of a total oil amount in the rubber material.

A seal component of the present invention is molded from the rubber material.

A hose of the present invention is molded from the rubber material.

The following are effects of the present invention.

(1) Rubber polymer is blended with a high molecular weight hydrocarbon-based oil having a weight average molecular weight of 5000 or more as well as a low molecular weight hydrocarbon-based oil having a weight average molecular weight of 1500 or less that has been conventionally added, whereby transmission loss (dBA) of sound at 400 to 10000 Hz is increased, that is, sound insulation property is improved. Although the mechanism thereof has not been clearly ascertained, it is considered that addition of a high molecular weight hydrocarbon-based oil increases the number (density) of bonds of molecules of the oil or entanglements of molecules between the oil and the rubber polymer, friction that is caused when sound oscillation is transmitted increases as the number of entanglements increases, and the capability of converting sound to heat (absorbing sound) is increased.

(2) Although sound insulation property is improved by blending oil having a high molecular weight, when the whole oil in the rubber material is a high molecular weight hydrocarbon-based oil, the processability of the rubber material decreases. For example, when the rubber material is subjected to molding process with rollers, the rubber material may adhere to the rollers. To prevent it, a high molecular weight hydrocarbon-based oil is blended in a rubber material in a state where a low molecular weight hydrocarbon-based oil exists therein, whereby sound insulation property is improved while the processability is secured.

### Advantageous Effects of Invention

The rubber material and the seal component and the hose of the present invention exert an excellent effect of increase in sound insulation property, without substantially changing the specific gravity or the foaming mode, consequently without increasing the weight.

### BRIEF DESCRIPTION OF DRAWINGS

FIG. 1A is a cross-sectional view of a weatherstrip for an automobile, and FIG. 1B is a cross-sectional view of a hose for an automobile, which are molded from a rubber material of an example.

### DESCRIPTION OF EMBODIMENTS

### 1. Rubber Polymer

Although the rubber polymer used herein is not limited to particular materials, examples thereof include ethylene-propylene-diene rubber (EPDM), ethylene propylene rubber (EPM), isobutylene isoprene rubber (IIR), isoprene rubber (IR), natural rubber (NR), butadiene rubber (BR), and styrene butadiene rubber (SBR).

### 2. Low Molecular Weight Hydrocarbon-Based Oil

Although the low molecular weight hydrocarbon-based oil used herein is not limited to particular materials, examples thereof include paraffin-based oils, naphthene-based oils, aromatic oils, and blended oils thereof. The weight average molecular weight of the low molecular weight hydrocarbon-based oil is 1500 or less as described above. The lower limit of the weight average molecular weight thereof is not limited to particular values, but is preferably 100 for its availability. Almost all of blended oils such as extender oils and process oils that are conventionally added to rubber materials can be used as preferable oils that correspond to the low molecular weight hydrocarbon-based oil having a weight average molecular weight of 100 to 1500.

### 3. High Molecular Weight Hydrocarbon-Based Oil

Although the high molecular weight hydrocarbon-based oil used herein is not limited to particular materials, examples thereof include co-oligomers of ethylene and α-olefin that are paraffin-based oils. The weight average molecular weight of the high molecular weight hydrocarbon-based oil is 5000 or more as described above for an effect of increasing sound insulation property. The upper limit of the weight average molecular weight thereof is not limited to particular values, but is preferably 50000 for its availability.

### 4. Other Ingredients

Other ingredients may be blended into the rubber material.

Although the other ingredients are not limited to particular materials, examples thereof include carbon black, zinc oxide, processing aids, antioxidants, and coloring agents. Other examples of the other ingredients include vulcanizing agents, vulcanization accelerators, and foaming agents that are blended in processing.

5. Molded Products Molded from the Rubber Material

Although molded products molded from the rubber material of the present invention are not limited to particular products, the high sound insulation property of the rubber material can be effective, in particular, for seal components. Examples of the seal components include seal components such as weatherstrips, door glass runs, window frames, engine gaskets, sealing material for hoods, sealing material for interior or exterior components, sealing material for electrical components for vehicles such as automobiles, railroad vehicles, ships, and airplanes, and seal components such as window frames for buildings. Other examples of the molded products are hoses such as hoses for automobiles, in addition to seal components. Such hoses can reduce leakage of flowing sound of fluids in the hoses to the outside.

### Example 1

Rubber materials of Examples 1 to 7 and Comparative Examples 1 to 3 were prepared with compositions (blending numerical values are expressed with parts by mass) illustrated in Table 1 as follows, to mold foam rubber sheets.

TABLE 1

| Sample Name | | | | Example 1 | Example 2 | Example 3 | Example 4 | Example 5 |
|---|---|---|---|---|---|---|---|---|
| Rubber | Oil-extended EPDM | | | 120 | 120 | 120 | 120 | 120 |
| | (Oil extension amount of | | | (Polymer | (Polymer | (Polymer | (Polymer | (Polymer |
| | extender oil: 20 phr) | | | 100) | 100) | 100) | 100) | 100) |
| | Diene Type: ENB | | | (Oil 20) | (Oil 20) | (Oil 20) | (Oil 20) | (Oil 20) |
| | Diene Content Percentage | | | | | | | |
| | (wt %): 9.5 | | | | | | | |
| | Non-oil-extended EPDM | | | | | | | |
| | Diene Type: ENB | | | | | | | |
| | Diene Content Percentage | | | | | | | |
| | (wt %): 14.0 | | | | | | | |
| | | | Kinetic | | | | | |
| | | Molecular | Viscosity | | | | | |
| | | Weight | @100° C. (mm²/s) | | | | | |
| Oil | Process Oil | 700 | 30 | 61 | 43 | 25 | | |
| | Paraffin-based Oil (1) | 5600 | 150 | | | | | 70 |
| | Paraffin-based Oil (2) | 14000 | 2000 | | | | | |
| | Paraffin-based Oil (3) | 15000 | 2880 | 9 | 27 | 45 | 70 | |

| | | | | | | |
|---|---|---|---|---|---|---|
| Blended Material | Carbon Black | 120 | 120 | 120 | 120 | 120 |
| | Stearic Acid | 1 | 1 | 1 | 1 | 1 |
| | Zinc Oxide | 7 | 7 | 7 | 7 | 7 |
| | Other | 5 | 5 | 5 | 5 | 5 |

| | | | | | | |
|---|---|---|---|---|---|---|
| Vulcanizing Agent | Powder Sulfur | 1.2 | 1.2 | 1.2 | 1.2 | 1.2 |

| | | | | | | |
|---|---|---|---|---|---|---|
| Sulfur Compound | Oganic Vulcanizing Agent | 0.6 | 0.6 | 0.6 | 0.6 | 0.6 |
| | (Morpholine-based) | | | | | |
| | Thiazole-based | 2 | 2 | 2 | 2 | 2 |
| | Dithiocarbamate-based | 1.4 | 1.4 | 1.4 | 1.4 | 1.4 |
| | Sulfenamide-based | 0.3 | 0.3 | 0.3 | 0.3 | 0.3 |

| | | | | | | |
|---|---|---|---|---|---|---|
| Foaming Agent | OBSH Foaming Agent | 3.04 | 3.04 | 3.04 | 3.04 | 3.04 |

| Processability | | | | ○ | ○ | ○ | ○ | ○ |
|---|---|---|---|---|---|---|---|---|
| Physical Property | Specific Gravity | | | 0.7 | 0.7 | 0.7 | 0.7 | 0.7 |
| | Transmission Loss (dBA) at 400 to 10000 Hz | | | 42.4 | 43.6 | 44.3 | 45.4 | 42.4 |
| Sample | | | | Example | Example | Comparative | Comparative | Comparative |
| Name | | | | 6 | 7 | Example 1 | Example 2 | Example 3 |
| Rubber | Oil-extended EPDM | | | 120 | | 120 | | |
| | (Oil extension amount of | | | (Polymer | | (Polymer | | |
| | extender oil: 20 phr) | | | 100) | | 100) | | |
| | Diene Type: ENB | | | (Oil 20) | | (Oil 20) | | |
| | Diene Content Percentage | | | | | | | |
| | (wt %): 9.5 | | | | | | | |
| | Non-oil-extended EPDM | | | | 100 | | 100 | 100 |
| | Diene Type: ENB | | | | | | | |
| | Diene Content Percentage | | | | | | | |
| | (wt %): 14.0 | | | | | | | |
| | | | Kinetic | | | | | |
| | | Molecular | Viscosity | | | | | |
| | | Weight | @100° C. (mm²/s) | | | | | |
| Oil | Process Oil | 700 | 30 | | 9 | 70 | 90 | |
| | Paraffin-based Oil (1) | 5600 | 150 | | | | | |
| | Paraffin-based Oil (2) | 14000 | 2000 | 70 | | | | |
| | Paraffin-based Oil (3) | 15000 | 2880 | | 81 | | | 90 |

| | | | | | | |
|---|---|---|---|---|---|---|
| Blended Material | Carbon Black | 120 | 120 | 120 | 120 | 120 |
| | Stearic Acid | 1 | 1 | 1 | 1 | 1 |
| | Zinc Oxide | 7 | 7 | 7 | 7 | 7 |
| | Other | 5 | 5 | 5 | 5 | 5 |

| | | | | | | |
|---|---|---|---|---|---|---|
| Vulcanizing Agent | Powder Sulfur | 1.2 | 1.2 | 1.2 | 1.2 | 1.2 |

| | | | | | | |
|---|---|---|---|---|---|---|
| Sulfur Compound | Oganic Vulcanizing Agent | 0.6 | 0.6 | 0.6 | 0.6 | 0.6 |
| | (Morpholine-based) | | | | | |
| | Thiazole-based | 2 | 2 | 2 | 2 | 2 |
| | Dithiocarbamate-based | 1.4 | 1.4 | 1.4 | 1.4 | 1.4 |
| | Sulfenamide-based | 0.3 | 0.3 | 0.3 | 0.3 | 0.3 |

| | | | | | | |
|---|---|---|---|---|---|---|
| Foaming Agent | OBSH Foaming Agent | 3.04 | 3.04 | 3.04 | 3.04 | 3.04 |

| Processability | | ○ | ○ | ○ | ○ | X |
|---|---|---|---|---|---|---|
| Physical Property | Specific Gravity | 0.7 | 0.7 | 0.7 | 0.7 | — |
| | Transmission Loss (dBA) at 400 to 10000 Hz | 42.9 | 43.2 | 41.5 | 40.3 | — |

The following EPDMs were used as the rubber polymer. Table 1 illustrates the types and the content percentages of the diene.

Oil-extended EPDM: trade name “Mitsui EPT 8120E” of Mitsui Chemicals, Inc. The EPDM has an oil extension amount of 20 phr (parts by mass of the extender oil for 100 parts by mass of rubber). The weight average molecular weight of the extender oil thereof is not publicized, but is estimated as 1500 or less. Accordingly, 120 parts by mass of the oil-extended EPDM can be regarded as being formed of 100 parts by mass of EPDM polymer and 20 parts by mass of extender oil having a weight average molecular weight of 1500 or less.

Non-oil-extended EPDM: trade name “Mitsui EPT 9090M” of Mitsui Chemicals, Inc. 100 parts by mass of the non-oil-extended EPDM can be regarded as 100 parts by mass of EPDM polymer.

The following oils were used as the oil. Table 1 illustrates the molecular weights and the kinetic viscosities (100° C.) thereof.

Process oil: trade name “Diana Process Oil PS-380” of Idemitsu Kosan Co., Ltd. The oil is a paraffin-based mineral oil, and used as process oil for rubber materials.

Paraffin-based oil (1): trade name “LUCANT HC-150” of Mitsui Chemicals, Inc. The oil is a paraffin-based oil (co-oligomer of ethylene and α-olefin, and hydrocarbon-based synthetic oil not including any polar group), and used as, for example, high viscosity base oil of lubricants.

Paraffin-based oil (2): trade name “LUCANT HC-2000” of Mitsui Chemicals, Inc. The oil is also a co-oligomer of ethylene and α-olefin that is a paraffin-based oil, and used as, for example, a viscosity index improver.

Paraffin-based oil (3): trade name “LUCANT HC-3000X” of Mitsui Chemicals, Inc. The oil is also a co-oligomer of ethylene and α-olefin that is a paraffin-based oil, and used as, for example, a viscosity index improver.

Accordingly, Examples 1 to 7 include one or both of an extender oil and a process oil in the oil-extended EPDM as the low molecular weight hydrocarbon-based oil having a weight average molecular weight of 1500 or less, and one of the paraffin-based oils (1) to (3) as the high molecular weight hydrocarbon-based oil having a weight average molecular weight of 5000 or more. The blending percentage of the high molecular weight hydrocarbon-based oil to the total oil amount in the rubber material is 10 percent by mass in Example 1, 90 percent by mass in Example 7, and intermediate values between them in Examples 2 to 6.

By contrast, Comparative Examples 1 and 2 include one or both of an extender oil and a process oil in the oil-extended EPDM as the low molecular weight hydrocarbon-based oil having a weight average molecular weight of 1500 or less, but do not include high molecular weight hydrocarbon-based oil having a weight average molecular weight of 5000 or more. Comparative Example 3 does not include low molecular weight hydrocarbon-based oil having a weight average molecular weight of 1500 or less, but includes the paraffin-based oil (3) as the high molecular weight hydrocarbon-based oil having a weight average molecular weight of 5000 or more.

The carbon black used was SRF having an iodine adsorption capacity of 20 mg/g and a DBP absorption capacity of 115 cm³/100 g.

The stearic acid used was stearic acid having trade name “LUNAC S-50V” of Kao Corporation.

The zinc oxide used was zinc oxide having trade name “META Z-102” of Inoue Calcium Corporation.

The vulcanizing agent used was sulfur powder.

The foaming agent used was OBSH (p,p′-oxybisbenzenesulfonylhydrazide) foaming agent.

The blending amounts of them were common to Examples 1 to 7 and Comparative Examples 1 to 3.

The rubber materials of Examples 1 to 7 and Comparative Examples 1 to 3 described above were weighed to have the respective blending ratios of Table 1, and kneaded to make materials using a Banbury mixer and rollers. Each of the kneaded materials was molded into a foam sheet having a thickness of 1.2 mm.

The following evaluations were made for the prepared foam rubber sheet.

1. Processability

The rubber materials that could be processed without any problems when kneaded with the rollers were rated as “◯” for “processability”.

The rubber material that could not be kneaded during kneading process with the rollers because the rubber material adhered to the surfaces of the rollers and was unable to be removed from the surfaces was rated as “x” for “processability”.

2. Sound Insulation Property

Each of the prepared foam rubber sheets was set in a jig having an opening area of 10 mm×90 mm, to measure its sound transmission loss (dBA) at 400 Hz to 10000 Hz under the atmosphere of 23° C. The sheet having a higher transmission loss can be rated as excellent in sound insulation property.

The foam rubber sheets of Examples 1 to 7 and Comparative Examples 1 and 2 had the same specific gravity, and the foam modes of them were the same in visual inspection.

However, the foam rubber sheets of Examples 1 to 7 had sound transmission losses (dBA) at 400 Hz to 10000 Hz that were clearly higher than those of Comparative Examples 1 and 2, and had improved sound insulation property.

In addition, the rubber material adhered to the rollers in Comparative Example 3 in which the whole amount of the oil in the rubber material was high molecular weight hydrocarbon-based oil. Such a problem did not occur in Examples 1 to 7 in which low-molecular weight hydrocarbon-based oil was blended as well as the high molecular weight hydrocarbon-based oil, and Examples 1 to 7 exhibited good processability.

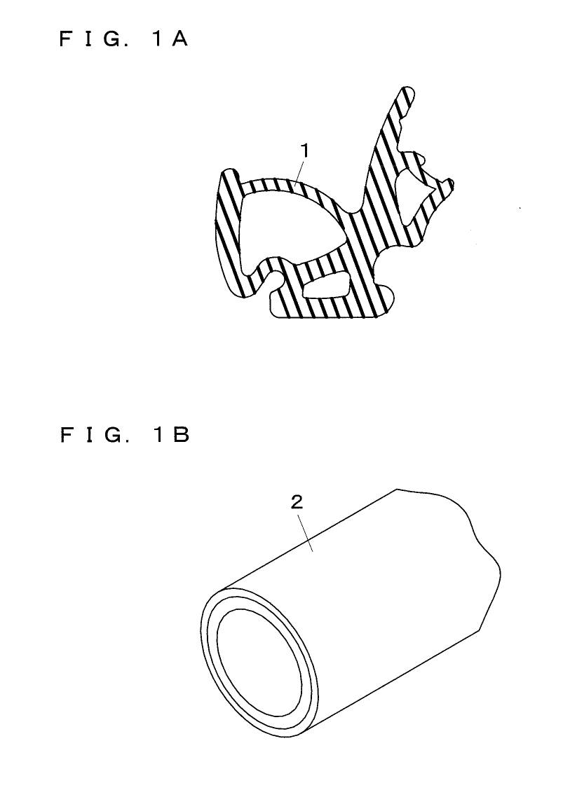

FIG. 1 illustrates a weatherstrip 1 (cross section) for an automobile and a hose 2 that feeds fuel, coolant, or air for an automobile, which were molded from the rubber materials of Examples 1 to 7. The weatherstrip 1 has improved sound insulation property against sound that tends to pass through the weatherstrip 1. The hose 2 enables reduction in leakage of flowing sound of the fuel, coolant, or air in the hose to the outside.

The present invention is not limited to the above examples, but may be carried out with proper modifications within a range not departing from the gist of the invention.

### REFERENCE SIGNS LIST

1 weatherstrip
2 hose

1. A rubber material comprising rubber polymer with which a low molecular weight hydrocarbon-based oil having a weight average molecular weight of 1500 or less and a high molecular weight hydrocarbon-based oil having a weight average molecular weight of 5000 or more are blended.

2. The rubber material according to claim 1, wherein
the high molecular weight hydrocarbon-based oil is blended in an amount of 10 to 90 percent by mass of a total oil amount in the rubber material.

3. A seal component molded from the rubber material according to claim 1.

4. A seal component molded from the rubber material according to claim 2.

5. A hose molded from the rubber material according to claim 1.

6. A hose molded from the rubber material according to claim 2.
